(19) United States
(12) Patent Application Publication
(10) Pub. No.: US 2014/0159271 A1
(43) Pub. Date: Jun. 12, 2014

(54) METHOD OF MANUFACTURING A MICROPOROUS POLYETHYLENE FILM

(71) Applicants: Tatsuya Itou, Nasushiobara-shi (JP); Koichi Kono, Nasushiobara-shi (JP)

(72) Inventors: Tatsuya Itou, Nasushiobara-shi (JP); Koichi Kono, Nasushiobara-shi (JP)

(73) Assignee: TORAY BATTERY SEPARATOR FILM CO., LTD., Nasushiobara-shi (JP)

(21) Appl. No.: 14/233,243

(22) PCT Filed: Apr. 20, 2012
(86) PCT No.: PCT/JP2012/060649

§ 371 Date: Jan. 16, 2014

(30) Foreign Application Priority Data
Jul. 22, 2011 (JP) 2011-160666
Oct. 14, 2011 (JP) 2011-226309
Dec. 2, 2011 (JP) 2011-264325

(51) Int. Cl. H01M 2/14

(52) U.S. Cl. CPC H01M 2/145
USPC 264/48

(57) ABSTRACT

A method of producing a microporous polyethylene film includes blending polyethylene and a membrane-forming solvent, stretching a sheet formed by extrusion through a die by stretching the sheet in the longitudinal direction at a stretching magnification of 1.1 to 2.0 and stretching the sheet simultaneously in the longitudinal direction and the width direction at an area magnification of 4 to 50, and removing the membrane-forming solvent.

### TECHNICAL FIELD

The present invention relates to a method of producing a microporous membrane widely used as a separation membrane used, for example, for separation and selective permeation of substances, a separator material in electrochemical reactors such as alkaline batteries, lithium secondary batteries, fuel cells, and capacitors, and the like. The present invention particularly relates to method of producing a polyolefin microporous membrane suitably used as a lithium ion battery separator.

### BACKGROUND ART

Polyolefin microporous membranes have been widely used as a separation membrane, separator, and the like used for separation and selective permeation of various substances. For example, polyolefin microporous membranes have been used as a microfiltration membrane, fuel cell separator, capacitor separator, and the like. In particular, polyolefin microporous membranes have been suitably used as a lithium ion battery separator that is widely used in notebook personal computers, cellular phones, digital cameras, and the like. One reason for that is that polyolefin microporous membranes have excellent mechanical strength and shutdown property.

Lithium ion battery separators need to have excellent heat shrinkage properties at high temperatures: e.g., providing excellent results in a high-temperature cycle test, oven test, or the like in a state of a battery. However, high strength, shutdown property, and high porosity are in a trade-off relationship with heat shrinkage rate, and it has been difficult to efficiently produce a separator with excellent balance between such properties.

For example, Patent Document 1 discloses a method of producing a polyethylene microporous membrane comprising subjecting a mixture containing a membrane-forming solvent to a first stretching and then subjecting a microporous membrane from which the membrane-forming solvent has been removed to a second stretching.

Patent Document 2 discloses a method of producing a polyolefin microporous membrane (lamination method), in which method polyethylene and a membrane-forming solvent are each extruded through a different die, and then two-stage stretching at different temperatures is performed to produce a laminated membrane.

### PRIOR ART DOCUMENTS

### Patent Documents

Patent Document 1: JP 2007-63547 A
Patent Document 2: WO 2007/046473

### SUMMARY OF THE INVENTION

### Problems to be Solved by the Invention

When the second stretching is carried out after removing a membrane-forming solvent as disclosed in Patent Document 1, examples of the method of stretching a microporous membrane in the longitudinal direction include the roll stretching method comprising preheating a film to a predetermined temperature and then stretching the film between at least one pair of rolls by utilizing the difference in peripheral speed and the clip stretching method comprising holding both ends of a film with clips and stretching the film by expanding the space between the clips in the longitudinal direction. In the former method, if foreign substances are attached to the rolls or the film surface, it is likely that surface defects such as pinholes impair the film quality. The clip stretching method has problems in that an expensive stretching apparatus is used, which results in poor cost-effectiveness, and in addition that the film is prone to breakage because the degree of stretching at the clip-holding portion is higher than that at the product portion.

According to the prior art disclosed in Patent Document 2, a good balance between air permeability, heat shrinkage resistance, and the like is provided, but the stiffness in the longitudinal direction of a film is insufficient, which can cause defects when winding up a separator incorporated in a battery.

### Means for Solving the Problems

Thus, the present invention provides

(1) A method of producing a microporous polyethylene film, comprising:
blending polyethylene and a membrane-forming solvent;
stretching a sheet formed by extrusion through a die; and
removing the membrane-forming solvent, wherein the stretching comprises the steps of stretching the sheet in the longitudinal direction at a stretching magnification of 1.1 to 2.0 and stretching the sheet simultaneously in the longitudinal direction and the width direction at an area magnification of 4 to 50,
(2) The method of producing a microporous polyethylene film according to (1), wherein the step of stretching the film in the longitudinal direction at a stretching magnification of 1.1 to 2.0 is carried out at 110 to 120° C.,
(3) The method of producing a microporous polyethylene film according to (1) or (2), wherein the step of stretching the sheet simultaneously in the longitudinal direction and the width direction at an area magnification of 4 to 50 is carried out at 115 to 125° C.,
(4) The method of producing a microporous polyethylene film according to any one of (1) to (3), wherein additional stretching and heat treatment is performed after removing the membrane-forming solvent, and
(5) The method of producing a microporous polyethylene film according to (4), wherein the stretching after removing the membrane-forming solvent is carried out at a MD stretching magnification of 1.1 to 1.5 and a TD stretching magnification of 1.15 to 1.5.

### Effects of the Invention

The method of producing a microporous polyethylene film of the present invention provides a polyolefin microporous membrane with excellent balance between rigidity in the longitudinal direction, heat shrinkage properties, and air permeability.

### BEST MODE FOR CARRYING OUT THE INVENTION

In the present invention, polyethylene is used as a raw material. The polyethylene is preferably used in the form of a mixture of an ultra high molecular weight polyethylene having a weight average molecular weight of 1×10⁶ to 5×10⁶ and a high density polyethylene having a weight average molecular weight of 1×10⁵ to 8×10⁵.

The ultra high molecular weight polyethylene having a weight average molecular weight (Mw) of 1×10⁶ to 5×10⁶ is a polyethylene having a Mw of 1.0×10⁶ to 5.0×10⁶ which is a polyethylene homopolymer and/or polyethylene copolymer in which ethylene-derived repeating units are contained in an amount of 50% or more and, preferably, at least 85% of the repeating unit is polyethylene. Preferably, the ultra high molecular weight polyethylene has a MWD of 50 or less, more preferably 1.2 to 50.0.

The ultra high molecular weight polyethylene is preferably an ethylene homopolymer or an ethylene/α-olefin copolymer, wherein at least one comonomer such as α-olefin is contained in an amount of 5.0 mol % or less (the mol % being a value based on 100% of the copolymer). The comonomer is selected from, for example, at least one of propylene, 1-butene, 1-pentene, 1-hexene, 4-methyl-1-pentene, 1-octene, vinyl acetate, methyl methacrylate, and styrene. Such a polymer or copolymer can be produced using a Ziegler-Natta catalyst or a single-site catalyst. The ultra high molecular weight polyethylene preferably has a melting point of 134° C. or higher. Examples of the ultra high molecular weight polyethylene (UHMWPE) include HI-ZEX MILLION 240-m polyethylene.

The high density polyethylene having a weight average molecular weight of 1×10⁵ to 8×10⁵ is a polyethylene homopolymer and/or polyethylene copolymer in which ethylene-derived repeating units are contained in an amount of 50% or more and, preferably, at least 85% of the repeating unit is polyethylene, and its Mw is 1×10⁵ to 8×10⁵. Preferably, the high density polyethylene has a MWD in the range of 2 to 15 and an amount of terminal unsaturated group of less than 0.20/1.0×10⁴ carbon atoms. More preferably, the Mw is 4.0×10⁵ to 6.0×10⁵, and the MWD is 3.0 to 10.0. Further, the amount of terminal unsaturated group is preferably 0.14/1.0×10⁴ carbon atoms or less, more preferably 0.12/1.0×10⁴ carbon atoms or less, still more preferably 0.05 to 0.14/1.0×10⁴ carbon atoms, and even still more preferably 0.05 to 0.12/1.0×10⁴ carbon atoms (the lower limit is the limit of measurement).

The high density polyethylene is preferably an ethylene homopolymer or an ethylene/α-olefin copolymer, wherein the amount of at least one comonomer such as α-olefin is 5.0 mol % or less (the mol % being a value based on 100% of the copolymer). The comonomer is selected from, for example, at least one of propylene, 1-butene, 1-pentene, 1-hexene, 4-methyl-1-pentene, 1-octene, vinyl acetate, methyl methacrylate, and styrene. Such a polymer or copolymer can be produced using a Ziegler-Natta catalyst or a single-site catalyst.

“SUNFINE” (registered trademark) SH-800 or SH-810 (Asahi Kasei Chemicals Corporation) can be used as the high density polyethylene having a weight average molecular weight of 1×10⁵ to 8×10⁵.

In the present invention, a polyethylene composition comprising such an ultra high molecular weight polyethylene and a high density polyethylene is used. Examples of components other than the ultra high molecular weight polyethylene and the high density polyethylene include fillers, antioxidants, stabilizers, and/or heat resistant resins. The type and kind of additives that are preferably used can be the same as those described in WO 2007/132942, WO 2008/016174, and WO 2008/140835.

### (Mixing and Extrusion Step)

In the present invention, a mixture containing an ultra high molecular weight polyethylene, a high density polyethylene, and a membrane-forming solvent is extruded, cooled, and solidified. Membrane-forming solvent is generally compatible with polymer and used for extrusion. For example, the membrane-forming solvent may be any type of solvent or a combination thereof and can be combined with a resin as a single phase at an extrusion temperature. Specific examples of membrane-forming solvents include aliphatic hydrocarbons and cyclic hydrocarbons, such as nonane, decane, decalin, paraffin oil, and phthalic acid esters such as dibutyl phthalate and dioctyl phthalate. Paraffin oil having a kinetic viscosity at 40° C. of 20×10⁻⁶ to 200×10⁻⁶ m²″sec can be preferably used, and the paraffin oil described in U.S. Patent Application Publication Nos. 2008/0057388 and 2008/0057389 can be used.

The mixing ratio of the membrane-forming solvent to the polyethylene composition is preferably 50% by mass:50% by mass to 90% by mass:10% by mass.

In the present invention, formation of the mixture (mixing) of the polyethylene composition and the membrane-forming solvent and extrusion are preferably carried out using a twin-screw extruder. The fillers and the like may be added via a side feeder.

The mixing is preferably carried out at a mixing energy of 0.1 to 0.65 KWh/kg. More preferably, the mixing energy is not less than 0.12 KWh/kg and less than 0.66 KWh/kg. When the mixing energy is in this range, the stretching magnification can be increased, and (a) a high yield point and (b) high strength can be provided. When the mixing energy is 0.12 KWh/kg or more, the planarity of a film improves. When the mixing energy is more than 0.66 KWh/kg, biaxial stretchability can be poor due to polymer degradation, making it difficult to conduct 3×3-fold or more stretching.

The mixture mentioned above is mixed in an extruder at a rotation rate of 450 rpm or less, preferably 430 rpm or less, and more preferably 410 rpm or less, and preferably 150 rpm or more, and more preferably 250 rpm or more. The temperature during mixing of the mixture of the polyethylene composition and the membrane-forming solvent is 140° C. to 250° C., preferably 210° C. to 240° C.

The mixture of the polyethylene composition and the membrane-forming solvent is extruded through a die to form an extrudate. The extrudate is adjusted to have a preferred thickness for the following step such that a desired thickness (1.0 lam or more) of a final membrane after stretching can be achieved. For example, the thickness of the extrudate is 0.1 mm to 10 mm or 0.5 to 5 mm. The extrusion is carried out with the mixture in the molten state. When a die for producing a sheet is used, the die is generally heated to 140 to 250° C. Preferred production conditions are described in WO 2007/132942 and WO 2008/016174.

If desired, the extrudate is exposed to a temperature in the range of 15 to 80° C. to form a cooled extrudate. Cooling rate, though not critical, is preferably less than 30° C./min, and the extrudate is cooled to around the gelation temperature of the extrudate. Production conditions for cooling are described in WO 2007/132942, WO 2008/016174, and WO 2008/140835.

### Stretching (Upstream Stretching) of Extrudate

The extrudate or cooled extrudate is stretched in the longitudinal direction at a stretching magnification of 1.1 to 2.0. Too small a stretching magnification results in ununiform stretching with a necked portion to impair uniform thickness or makes it difficult to achieve a desired strength in the longitudinal direction. Too large a stretching magnification increases the molecular orientation in the longitudinal direction, and film breakage is likely to occur in the following biaxial stretching step to decrease the productivity. In view of uniformity of film thickness and uniformity of pore shape, the stretching temperature is preferably 110 to 120° C., more preferably in the range of 115 to 118° C.

To commercially realize such stretching, a method comprising conducting the cooled sheet described above to a stretching apparatus comprising a plurality of roll systems (roll stretching apparatus), preheating the sheet with a plurality of heating rolls, followed by stretching the preheated sheet in the longitudinal direction between at least one pair of rolls utilizing the difference in peripheral speed, and immediately cooling the stretched sheet with a cooling roll is preferred because of excellent process stability and equipment efficiency. The preheating step involves a plurality of roll apparatuses, and a metal roll, ceramic roll, rubber roll, and the like can be used as the roll. A heating method, e.g., a method using a fluid that circulates in the roll such as heating medium, hot water, pressurized hot water, vapor, or the like, an induction heating method, or the like is selected as appropriate. In the stretching step, the sheet is stretched between at least one pair of rolls, but the sheet can be stretched in a multistage manner using a plurality of pairs of roll systems. In this case, stretching the sheet by driving a plurality of rolls at given peripheral speeds or stretching the sheet using a pair of rolls provided with a difference in peripheral speed between which a plurality of free rolls is arranged is selected as appropriate. Further, on the assumption that the range of the stretching magnification in the longitudinal direction in the stretching step (1.1 to 2.0) is satisfied, an annealing step of less than 1.0-fold can be combined.

The surface of the sheet is slippery because of the membrane-forming solvent. Thus, in the stretching step, it is preferable to employ a nip system in order to fix the sheet on a stretching roll, and it is preferable to press the sheet onto the stretching roll with a rubber roll to prevent slipping. Examples of the material of the rubber roll include synthetic rubbers such as silicone and chloroprene. Silicone rubber has excellent heat resistance and is preferably used. Next, the extrudate or cooled extrudate is stretched simultaneously in MD (longitudinal direction) and TD (width direction) at an area magnification of 4 to 50 (upstream stretching or wet stretching). Such stretching results in orientation in the polymer in the mixture. The extrudate can be stretched using a tenter, and roll stretching, the inflation method, or a combination thereof can be used. The stretching temperature in this case is preferably 115 to 125° C., more preferably 118 to 125° C., and still more preferably 119 to 123° C.

By comprising such a specific stretching step using a specific stretching magnification, excellent rigidity in the longitudinal direction can be provided while maintaining air permeability and heat shrinkage properties.

### Removal of Membrane-Forming Solvent

To obtain a dried membrane, the membrane-forming solvent is removed from a stretched extrudate. Solvent for removal is used to remove the membrane-forming solvent. The method for this is described, for example, in WO 2008/016174.

Residual volatile components are removed from the dried membrane after removing diluent components. Various methods can be used to remove washing solvent, e.g., heat-drying, air-drying, and the like. For conditions of the washing solvent for removing volatile components, the same method as in WO 2008/016174 can be used.

### Stretching (Downstream Stretching) of Membrane

Stretching of the dried membrane (referred to as “downstream stretching” or “dry stretching”, the dried membrane is stretched after at least the membrane-forming solvent has been removed) is preferably carried out in at least one direction, e.g., MD and/or TD. Such stretching results in orientation of the polymer in the membrane. In downstream stretching before dry stretching, TD length in the width direction is called an initial dry width, and MD length in the length direction is called an initial dry length. Equipment in the tenter stretching method is described in WO 2008/016174, and the same method can be used.

In the downstream stretching, the stretching magnification in MD and TD can be appropriately selected to achieve the desired film physical properties. However, according to the present technique, the upstream stretching increases the orientation in MD, and the MD stretching, if carried out, is preferably at a low magnification in the range of 1 to 1.3, more preferably 1 to 1.2, relative to the initial dry length. The TD stretching magnification is preferably 1.1 to 1.6 relative to the initial dry width because the film will have good quality uniformity. Particularly in battery applications, in general, the stretching magnification in TD preferably does not exceed the total stretching magnification in MD because heat shrinkage in TD has a great influence on battery properties compared to heat shrinkage in MD. The total MD stretching magnification is defined as the product of upstream MD stretching magnification and downstream MD stretching magnification. More preferably, the MD stretching magnification is 1.1 to 1.5, and still more preferably 1.2 to 1.4; the TD stretching magnification is 1.15 to 1.5, and still more preferably 1.2 to 1.4. Within this range, the upstream MD stretching magnification and the downstream MD stretching magnification can be apportioned as appropriate.

In the dry stretching in MD and TD, sequential stretching or simultaneous biaxial stretching can be used. In the case of biaxial stretching, the membrane is preferably stretched simultaneously in MD and TD. When the dry stretching is sequential stretching, the membrane is preferably stretched in MD and then in TD.

In the dry stretching, the dried membrane is stretched at a temperature not higher than Tm, e.g., in the range of crystal dispersion temperature (Tcd)−30° C. to Tm. The membrane is exposed to a temperature in the range of 70° C. to 135° C., preferably 120° C. to 132° C., and more preferably 128° C. to 132° C. The Tcd and Tm as used herein are values of Tcd and Tm of a polyethylene having a lowest melting point among the polyethylenes that are used in the extrudate and mixed in an amount of 5 parts by weight or more. The crystal dispersion temperature is determined as a temperature of the properties of the dynamic viscoelasticity measurement described in ASTM D4065.

The stretching rate is preferably 3%/sec or more in both MD and TD, and each individually selected. The stretching rate is more preferably 5%/sec or more, and still more preferably 10%/sec or more. The stretching rate is preferably in the range of 5 to 25%/sec. The upper limit is preferably 50%/sec to prevent membrane rupture.

### Heat Treatment Step

It is believed that the heat treatment step stabilizes crystals and forms uniform lamellas in the membrane, and annealing relieves the stress-strain remaining in the membrane. In the heat treatment step of the present invention, in at least a part of the step, the heat treatment is continuously performed with a microporous membrane being separated from clips holding both ends of the microporous membrane. The heat treatment is performed by exposing the membrane to a temperature between Tcd and Tm, preferably 100° C. to 135° C., more preferably 120° C. to 132° C., and still more preferably 122° C. to 130° C. The heat treatment temperature can be the same temperature as a downstream stretching temperature. The heat treatment is generally performed for a time sufficient to form uniform lamellas in the membrane and to relieve the stress-strain remaining in the membrane by annealing. From the standpoint of productivity, the heat treatment is preferably performed for a time in the range of 1 to 300 sec, more preferably in the range of 1 to 120 sec.

After the heat treatment step, the polyolefin microporous membrane is wound up.

The present invention achieves excellent productivity because extrusion, stretching, removal of membrane-forming solvent, drying, and heat treatment can be carried out continuously.

The polyolefin microporous membrane obtained by the present invention mentioned above has excellent heat shrinkage properties, and a polyolefin microporous membrane having excellent heat shrinkage properties can be produced continuously with high productivity.

### EXAMPLES

Specific examples in the present invention will now be described by way of example, but the present invention is not limited thereto.

### (Evaluation Method)

### 1. Thickness

The thickness of a microporous membrane was determined by measuring the thickness five times with a contact thickness meter at 5-mm longitudinal intervals over a width of 30 cm and averaging the measurements. A thickness meter such as Rotary Caliper RC-1 manufactured by Mitsutoyo Corporation can be used.

### 2. Pin Puncture Strength

A maximum load was measured when a microporous membrane having a thickness T₁ was pricked with a needle of 1 mm in diameter with a spherical end surface (radius R of curvature: 0.5 mm) at a speed of 2 mm/sec. The measured maximum load L₁ was converted to a maximum load L₂ (thickness: 20 μm) using the equation: L₂=(L₁×20)/T₁, and the converted value was used as a pin puncture strength.

### 3. Porosity

The porosity of a microporous membrane is measured by comparison between the mass of the microporous membrane (w₁) and the weight of an equivalent non-porous polymer (w₂) (a polymer of the same width, length, and composition). The porosity is determined by the following equation, and the average value of five measurements is used.

Porosity(%)−(w₂−w₁)/w₂×100

### 4. Heat Shrinkage Rate

The heat shrinkage rate at 105° C. in the planar direction (MD, TD) of a microporous membrane is measured as described below. (i) The size of a microporous membrane at 23° C. is measured (MD and TD). (ii) The sample is exposed to conditions of 105° C. for 8 hours with no load applied. (iii) The size in MD and TD is then measured. The heat shrinkage rate in MD and TD is a value determined by dividing the size of (iii) by the size of (i) and subtracting 1 from the quotient (expressed as a percentage). The same measurements were made for three samples, and the average value was used as a heat shrinkage rate.

### 5. Air Permeability

The air permeability P₁ of a microporous membrane having a thickness of T₁, as measured in accordance with JIS P 8117, was converted to an air permeability P₂ (thickness: 20 μm) using the equation: P₂=(P₁×20)/T₁. The measurements were made three times, and the average value is used as an air permeability.

### 6. Rigidity in the Longitudinal Direction

Tensile strength was measured in the longitudinal direction (MD). The measurements were made using a strip test piece 10 mm wide according to ASTM D882. The measurements were made three times, and the average value was used as a rigidity in the longitudinal direction.

### 7. Molecular Weight

Gel permeation method (GPC) is used. The molecular weight is calculated using monodisperse polystyrene standards, as defined below.

Number Average Molecular Weight: Mn=(Σni·Mi)/Σni

Weight Average Molecular Weight: Mw=(Σni·Mi²)/(Σni·Mi)

Polydispersity Index Mw/Mn

Measuring apparatus: GPC-150C available from Waters Corporation
Column: Shodex UT806M available from SHOWA DENKO K.K.

### Column Temperature: 135° C.

Solvent (mobile phase): o-dichlorobenzene
Solvent flow rate: 1.0 mL/min
Sample Concentration: 0.1% by mass (dissolution conditions: 135° C./hr)
Injection amount: 500 μL
Detector: Differential refractometer available from Waters Corporation
Calibration curve: Generated from a calibration curve of a monodisperse polystyrene standard sample using a predetermined conversion constant.

### 8. Melting Point and Crystallization Temperature

Using differential scanning calorimetry, measurements are made under the following conditions.

Measuring apparatus: Pyris 1 DSC available from PerkinElmer Inc. is used.
Measurement method: A sample, the amount of which is adjusted to 5.5 to 6.5 g, is sealed in an aluminum pan, and the temperature is raised from 30° C. to 230° C. at a rate of 10° C./min and held at 230° C. for 10 min. The sample is then cooled from 230° C. to 25° C. at a cooling rate of 10° C./min (crystallization) and held at 25° C. for 10 min. Thereafter, the temperature is raised to 230° C. at a rate of 10° C./min (second melt). The thermal analyses in both the crystallization and the second melt are recorded. The melting point (Tm) is the peak of the second melting curve. Measurements were made for three samples, and the average value is used.

### 9. Crystal Dispersion Temperature

Under the following conditions, dynamic viscoelastic behavior is measured to determine the relaxation peak of a crystal lattice, which peak is used as a crystal dispersion temperature. The measurements are made by the method described in ASTM D4065.

### Example 1

### (1) Preparation of Mixture of Polymer and Membrane-Forming Solvent

A mixture of polymer and membrane-forming solvent is prepared by mixing liquid paraffin with a blend of polyethylene 1 (PE1) and polyethylene 2 (PE2). The polymer blend comprises (a) 95% by mass of PE1 having a Mw of 3.0×10⁵, a MWD of 4.05, an amount of terminal unsaturated group of 0.14/1.0×10⁴ carbon atoms, and a melting point Tm of 136.0° C., and (b) 5% by mass of PE2 having a Mw of 2.0×10⁶ and a melting point of 136.0° C. “% by mass” is based on the weight of the mixed polymer.

### (2) Production of Membrane

The mixture of polymer and membrane-forming solvent was fed to an extruder and extruded through a sheet-forming die in the form of a sheet-like extrudate. The die temperature was 210° C. The extrudate was cooled using a cooling roll at 20° C. The cooled extrudate was stretched 1.4-fold at 115° C. and then, using a tenter, simultaneously biaxially stretched at 117° C. at a stretching magnification of 5 in both TD and MD. The stretched gel-like sheet was immersed in methylene chloride at 25° C. Thereafter, the liquid paraffin was removed, and then the resultant was dried under air flow at room temperature. During this process, the membrane was held at a constant size and then dry-stretched 1.1-fold in TD at a temperature of 128° C. and a stretching rate of 7%/sec using a tenter to form a final microporous polyethylene film. Raw materials, process conditions, and membrane properties are shown in Table 1.

### Example 2

A microporous polyethylene film was obtained in the same manner as in Example 1 except that the cooled extrudate was stretched 1.8-fold at 120° C. and then, using a tenter, simultaneously biaxially stretched at 123° C. at a stretching magnification of 5 in both TD and MD. The membrane-forming conditions and the measurement results are shown in Table 1.

### Example 3

A microporous polyethylene film was obtained in the same manner as in Example 1 except that stretching was not performed after removing the liquid paraffin. The membrane-forming conditions and the measurement results are shown in Table 1.

### Comparative Example 1

A microporous polyethylene microporous membrane was obtained in the same manner as in Example 1 except that 1.4-fold stretching was not performed after extruding the mixture and simultaneous biaxial stretching was performed at 117° C. at a stretching magnification of 5 in both TD and MD using a tenter. The membrane-forming conditions and the measurement results are shown in Table 1.

### Comparative Example 2

A microporous polyethylene microporous membrane was obtained in the same manner as in Example 1 except that 2.2-fold stretching was performed at 115° C. after extruding the mixture and simultaneous biaxial stretching was performed at 120° C. at a stretching magnification of 5 in both TD and MD using a tenter. The membrane-forming conditions and the measurement results are shown in Table 1.

TABLE 1

| | | | | | | Comparative | Comparative |
|---|---|---|---|---|---|---|---|
| | | | Example 1 | Example 2 | Example 3 | Example 1 | Example 2 |
| Polyethylene | HDPE (PE1): Mw/(Mw/Mn)/wt % | | 3.0 × 10⁵/8.6/95 | 3.0 × 10⁵/8.6/95 | 3.0 × 10⁵/8.6/95 | 3.0 × 10⁵/8.6/95 | 3.0 × 10⁵/8.6/95 |
| composition | UHMWPE (PE2): Mw/(Mw/Mn)/wt % | | 2.0 × 10⁶/8/5 | 2.0 × 10⁶/8/5 | 2.0 × 10⁶/8/5 | 2.0 × 10⁶/8/5 | 2.0 × 10⁶/8/5 |
| | Mw/Mn | | 11 | 11 | 11 | 11 | 11 |
| | Melting point (° C.) | | 134.5 | 134.5 | 134.5 | 134.5 | 134.5 |
| | Crystal dispersion temperature (° C.) | | 100 | 100 | 100 | 100 | 100 |
| | Crystallization temperature (° C.) | | 105 | 105 | 105 | 105 | 105 |
| Producing | Polyethylene composition concentration | | 30 | 30 | 30 | 30 | 30 |
| condition | (wt %) | | | | | | |
| | Cooling roller temperature (° C.) | | 30 | 30 | 30 | 30 | 30 |
| | Upstream stretching (the first): | | 115/1.4 | 120/1.8 | 115/1.4 | — | 115/2.2 |
| | temperature (° C.)/MD magnification | | | | | | |
| | Upstream stretching (the second): | | 117/5 × 5 | 123/5 × 5 | 117/5 × 5 | 117/5 × 5 | 120/5 × 5 |
| | temperature (° C.)/MD magnification | | | | | | |
| | Downstream stretching: | | 128/1 × 1.1 | 128/1 × 1.1 | 128/1 × 1.1 | 128/1 × 1.1 | 128/1 × 1.1 |
| | temperature (° C.)/MD magnification | | | | | | |
| Membrane | Membrane thickness (μm) | | 20.1 | 20.1 | 20.1 | 20.1 | 20.1 |
| properties | Air permeability (sec/100 cm³/20 μm) | | 230 | 245 | 240 | 225 | 280 |
| | Porosity (%) | | 38 | 38 | 38 | 38 | 38 |
| | Pin puncture strength (mN/20 μm) | | 4,610 | 4,730 | 4,650 | 4,550 | 4,780 |
| | Tensile strength (kPa) MD | | 135,000 | 144,000 | 139,000 | 130,000 | 146,000 |
| | Heat shrinkage | MD | 2.3 | 2.5 | 2.3 | 2.2 | 3.2 |
| | ratio (%) | TD | 2.8 | 3.2 | 2.5 | 2.3 | 2.5 |

### INDUSTRIAL APPLICABILITY

A polyolefin microporous membrane obtained by the production method of the present invention can be suitably used particularly as a lithium ion battery separator.

1. A method of producing a microporous polyethylene film comprising:
blending polyethylene and a membrane-forming solvent;
stretching a sheet formed by extrusion through a die by stretching the sheet in a longitudinal direction at a stretching magnification of 1.1 to 2.0 and stretching the sheet simultaneously in the longitudinal direction and a width direction at an area magnification of 4 to 50; and
removing the membrane-forming solvent.

2. The method according to claim 1, wherein stretching the film in the longitudinal direction at a stretching magnification of 1.1 to 2.0 is carried out at 110 to 120° C.

3. The method according to claim 1, wherein stretching the sheet simultaneously in the longitudinal direction and the width direction at an area magnification of 4 to 50 is carried out at 115 to 125° C.

4. The method according to claim 1, wherein additional stretching and heat treatment is performed after removing the membrane-forming solvent.

5. The method according to claim 4, wherein the stretching after removing the membrane-forming solvent is carried out at a MD stretching magnification of 1.1 to 1.5 and a TD stretching magnification of 1.15 to 1.5.

6. The method according to claim 2, wherein stretching the sheet simultaneously in the longitudinal direction and the width direction at an area magnification of 4 to 50 is carried out at 115 to 125° C.

7. The method according to claim 2, wherein additional stretching and heat treatment is performed after removing the membrane-forming solvent.

8. The method according to claim 3, wherein additional stretching and heat treatment is performed after removing the membrane-forming solvent.
